(19) United States
(12) Patent Application Publication
(10) Pub. No.: US 2012/0306399 A1
(43) Pub. Date: Dec. 6, 2012

(54) PROJECTOR SYSTEM WITH SINGLE INPUT, MULTIPLE OUTPUT DC-DC CONVERTER

(76) Inventors: Cristiano Bazzani, Irvine, CA (US); Fabio Gozzini, Newport Beach, CA (US)

(21) Appl. No.: 13/486,981

(22) Filed: Jun. 1, 2012

Related U.S. Application Data
(63) Continuation-in-part of application No. 13/302,991, filed on Nov. 22, 2011.
(60) Provisional application No. 61/520,053, filed on Jun. 3, 2011.
(60) Provisional application No. 61/458,443, filed on Nov. 22, 2010.

(51) Int. Cl. H05B 37/02

(52) U.S. Cl. 315/210

(57) ABSTRACT

A projector system with a single DC-DC converter having a single inductor is disclosed. A single DC-DC converter receives an input voltage and connects to two or more light sources such that each light source receives the same DC-DC converter output signal. Connected to the opposite terminal of the light source is a current source driver which receives a control signal control the voltage levels that determine which light source is the active or full power light source in the time multiplexed image generation arrangement. The use of a DC-DC converter having a single inductor reduces cost and size of the system while still enabling color mixing such that two or more light sources share the same single output of the DC-DC converter.

### PRIORITY CLAIM

This application claims priority to and the benefit of U.S. Provisional Patent Application filed on Jun. 3, 2011 having Application No. 61/520,053 entitled PROJECTOR SYSTEM WITH SINGLE INPUT, MULTIPLE OUTPUT DC-DC CONVERTER and is a continuation-in-part of U.S. patent application Ser. No. 13/302,991 filed Nov. 22, 2011 entitled COLOR MIXING AND DESATURATION WITH REDUCED NUMBER OF CONVERTERS which claims priority to and the benefit of U.S. Provisional Patent Application No. 61/458,443 filed Nov. 22, 2010 entitled COLOR MIXING AND DESATURATION WITH REDUCED NUMBER OF CONVERTERS.

### 1. FIELD OF THE INVENTION

This invention relates to projection systems and in particular to a method and apparatus for color mixing and a projection system using a single input, multiple output inductor in a DC-DC converter.

### 2. RELATED ART

In color sequential projection systems the image is composed with overlapping monochromatic images (usually RED, GREEN and BLUE generated by 3 separate light sources, typically LEDs or lasers) The light source may also be a white LED followed in the optical path by a color wheel however this is less common in portable systems due to the size and the potential unreliability of the color wheel.

The projected image is obtained by shining the light onto the pixilation engine (either a LCoS, LCD or DLP matrix) at a frequency higher than the speed of the human eye in such a way that the still image appears as a single uniform image, and the movement in a video image masks any possible transitions between colors. Often the color saturation obtained with overlapping images is higher than what is required by the application or what the video source is capable of offering so to increase overall brightness, color mixing or color de-saturation is used where each of the overlapped images in not purely monochromatic (single monochromatic light source on) but a primary color is present and other are “mixed-in” by turning on one or more additional LED/laser.

In a battery operated system or in general in systems where power dissipation is important, usually the voltage across the light source is regulated by a DC-DC converter so that the current required for the specific light output flows into the laser/LED at the minimum possible voltage required by the LED/laser for that particular current therefore minimizing overall power dissipation.

When color mixing is used, since more then one light source is enabled, multiple DC-DC converters are required to operate each of the light sources at optimal power dissipation level. However, utilizing multiple DC-DC converters makes the system expensive and requires more board space. In addition, each DC-DC converter has a standby power dissipation which adds to the overall power dissipation. In spite of that, in general, when multiple DC-DC converters are used (one for each light source), the system can be more efficient since each light source is operated at its optimal voltage drop. However the presence of this standby power dissipation reduces the benefit of using multiple DC-DC converters. In addition, the power advantage and usage of multiple DC-DC converter changes depending on drive current, laser/LED drop (i.e. power dissipated in each light source) and each DC-DC converter power dissipation.

Likewise, use of multiple DC-DC converters consumes excessive area which is at a premium. Hence, the use of multiple converters is undesirable. The method and apparatus disclosed herein overcomes the drawbacks of the prior art and provides additional benefits.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an example embodiment of a single converter color mixing and/or de-saturation system.

FIG. 2 is a block diagram of an exemplary embodiment of a multi-channel color mixing or de-saturation system with a single DC-DC converter.

FIG. 3 is a block diagram of an exemplary embodiment of an analog feedback loop in a color mixing or de-saturation system with a single DC-DC converter.

FIG. 4 is a block diagram of an exemplary embodiment of a color mixing or de-saturation system having a single DC-DC converter and a digital to analog converter sourcing current based on a code.

FIG. 5 illustrates a projector system with multiple DC-DC converters and light source components having an inductor associated with each DC-DC converter.

FIG. 6 illustrates an example embodiment of a projector system having a single output DC-DC converter configured with a single inductor.

FIG. 7 illustrates an example embodiment of a projector system having a DC-DC converter utilizing a single inductor with multiple outputs (SIMO).

FIGS. 8A-8C illustrate example embodiments of circuitry configured to generate control signals utilized the SIMO DC-DC converter of FIG. 7.

FIG. 9 illustrates an example embodiment of a controller or compensation system for a DC-DC converter.

FIG. 10 illustrates an example embodiment of a controller for a single input, multiple output (SIMO) DC-DC Converter.

### DETAILED DESCRIPTION

In certain embodiments, projection systems may be provided which project an optic image or video. These devices may be battery operated and thus is important for the projection system to minimized power consumption. It is also preferred to have an image or video with high image quality including brightness and saturation. In some systems two or more light sources are utilized and these two or more light sources may be utilized concurrently to increase brightness. To effectively trade-off power consumption and cost, a single converter, which may be a DC-DC converter is utilized. To minimize power consumption while providing reliable operation, the biasing of the diodes is set to the minimum voltage required to insure operation. However, different diodes may require different bias voltages. When multiple light sources are active at the same time, the biasing requirements must be maintained to achieve desired operation.

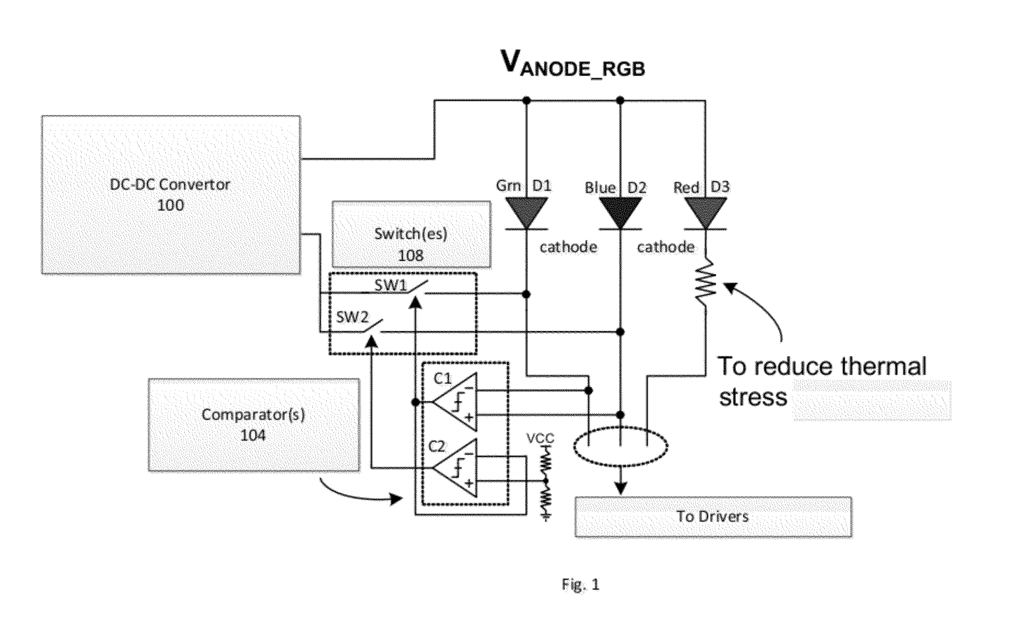

FIG. 1 illustrates an example projection system. In this example embodiment the light sources comprise light emitting diodes D1, D2, D3, but in other embodiment any type and number of light source may be utilized. The diodes D1, D2, D3 are biased by a Vanode voltage which is sourced from a DC-DC converter 100.

The outputs of the diodes D1, D2, D3 connect to drivers. To achieve desired operation of the drivers and diodes, sufficient voltage must be present between the diodes and the drivers for the drivers to generate or pull the amount of current to turn on the diodes, i.e. generate light.

Also part of this embodiment are switches 108, and in particular SW1 between the cathode side of the diode D1 and the converter 100. A switch SW2 is between the cathode side of the diode D2 and the converter 100. Additional switches may be provided including a switch connected between the diode D3 and the converter 100.

The switches 108 receive switch control signals from comparators 104. Comparators 104 include comparator C1 and comparator C2. The comparator C1 receives as inputs the signal on the cathode side of the diodes D1 and D2. D1 connects to the negative input of C1 while D2 connects to the positive input. C1 output controls SW1. C2 has a negative input connected to the output of C1 and a positive input connected to a resistive network between Vcc and ground. In this embodiment, the input to the positive terminal of C2 is 50% of Vcc. The output of C2 controls SW2. The comparator C2 may comprise an inverter as discussed below in greater detail. In this embodiment the comparators C2 was implemented as a comparator to allow the system to be system small in size and by using a single part having two comparators, less expensive that a separate comparator and inverter.

In operation the converter 100 provides the bias as Vanode to all of the diodes D1, D2, D3. It is contemplated that each of the different diodes, which may different in the color of the light output, may require a different bias voltage for operation. To reduce power consumption while maintaining desired biasing, the biasing established by the converter 100 is varied over time to match the biasing required for the diode in operation, and such diodes may be time multiplexed to generate the three color channels for the image or video. The switches 108 are configured to detect the voltage on the cathode side of the diode and in turn pass that input to the converter so that the converter can generate and provide the desired and required bias Vanode. Selectively controlling which switch 108 SW1, SW2 is closed and open will control the input that is provided to the converter 100. For example, if SW1 is closed, then the voltage at the cathode side of D1 is presented to the converter 100, and the converter 100 can process the voltage to determine or insure that the desired and required bias voltage Vanode is presented from the converter 100 as Vanode. It is contemplated that the converter 100 may set the Vanode voltage based on an in direct relation to a cathode voltage, or based on a stored and predetermined value. In one embodiment the switch that is closed is the switch that corresponds to the diode having a cathode voltage that is the smallest. Thus, if the lowest voltage is not provided to the DC-DC converter the system will not work since the Vanode should be at a minimum the one that allows both LED to operate.

Although typically only one light source is on at time in a time multiplexed manner, to increase brightness and improve image quality, more than one light source may be on at a time. For example, of the red diode D3 being on full for the time period designed to the red color channel, the other one or two diodes D1, D2 may be on to supplement the light output. Although the color of the light output from these diodes may be different, if not on at full intensity, the perceived image quality will not suffer.

Therefore, to allow the other diodes to turn on during the D3 diode's period for image generation, there must be sufficient voltage Vanode to bias D1 and D2. In addition, either of D1 or D2 may require a higher bias voltage Vanode and which of D1 or D2 requires the higher bias voltage may change during operation based any number of factors such as age, temperature, current, or other factors. Failure to sufficiently set bias for the diode that requires the higher bias voltage will result in that diode not emitting light, a possible color shift, and image quality will suffer. Continually maintaining too high a bias voltage wastes power resources and decreases battery life.

The comparators C1 compares the cathode side voltage of diodes D1 and D2, which are provided as inputs to the C1. If the voltage on the cathode side of D1 is less then the voltage on the cathode side of D2, then the output of the C1 is high and this results in SW1 being closed. The comparator C2 forces the SW2 open. As a result, the converter 100 sets the bias voltage Vanode based on the D1 requirements.

If cathode voltage of D2 is less than the cathode voltage of D1, then the output of C1 is low and this forces the SW1 open and C2 closes SW2. As a result, this sets the bias voltage Vanode based on the D2 requirements.

With regard to comparator C2, it receives as an input the output from C1 and as a second input in this embodiment 50% of Vcc. In operation, it acts as an inverter or a ‘not’ gate of the output of C1. Use of 50% of Vcc provides a generally constant and defined threshold or comparator value which is typically midway between the high or low output of C1.

This combination of the switches and the comparator detect which anode voltage is greater and responsive there to controls switches to connect the proper cathode voltage of D1 or D2 to the converter 100. In turn, the converter 100 establishes the bias voltage sufficiently high for the requirements of the particular light source (D1, D2) which requires the higher bias voltage, without wasting power.

This arrangement is shown in relation to D1 and D2 because the voltage biasing requirements for D3 red is typically less (lower voltage drop across D3 red) than D1 green and D2 blue diodes. However, it is contemplated that this arrangement of comparators, switches and interconnects may be applied to any diode or any number or type of light sources.

In addition to the system of FIG. 1 set forth above, also disclosed are additional methods and apparatus for utilizing a number of DC-DC converter which is less than the number of light sources in a projector system. Hence, one or multiple DC-DC converts may be utilized but there are a greater number of light sources such that at least one DC-DC converter is shared between light sources. As such, set forth below are additional embodiments. The methods and techniques highlighted in these innovations allow the automatic identification and selection of the light source (LED/Laser) that has the highest voltage drop so that system designers, engineers, and manufactures (hereinafter integrators) have the capability of trading off efficiency for cost of material and board area to obtain the best overall system.

In actual systems, the capability to automatically identify and set biasing, such as in this embodiment the common anode voltage, for the light source that has the highest voltage drop is extremely important because blue and green light sources usually have similar drops so the loss in efficiency from using a single converter multiplexed between light sources is negligible. Moreover, many systems employ multiple light sources (LED or laser diodes) of the same color to obtain higher brightness. Theoretically, the drop across the same light sources type and model is constant for the same current however tolerances in the devices will cause small variations in the drops which forces system integrators to use a separate DC-DC converter whenever more then one source is turned on at the same time.

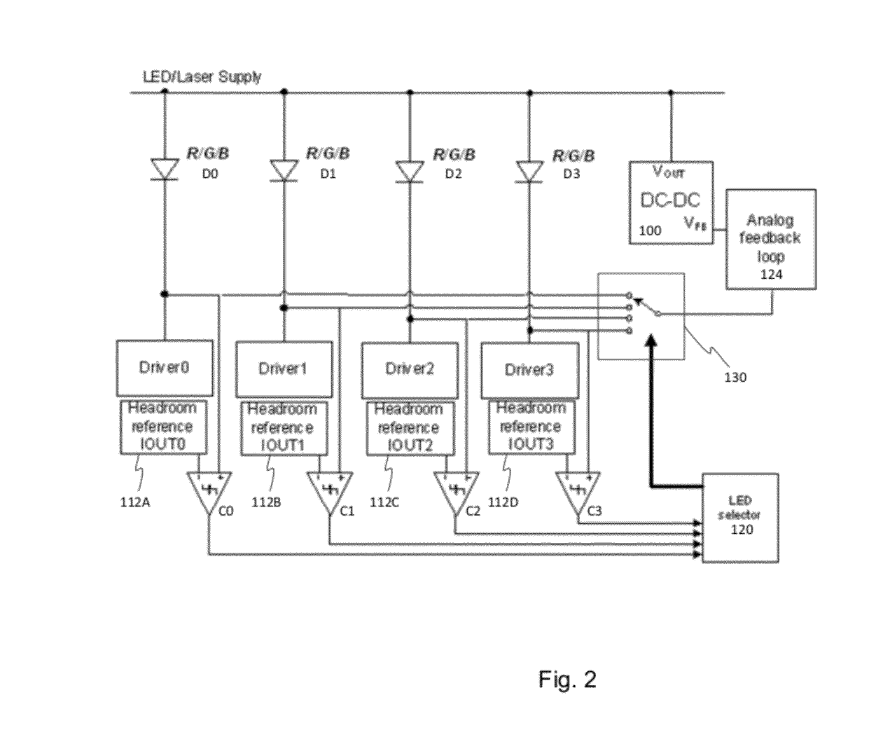

In addition to the method and apparatus described above a second method and apparatus is disclosed. This method provides greater capability but at a slight increase in complexity, although such increased complexity is negligible upon implementation and design. For example, the method described in connection with FIG. 1 works well when two or three channels need to be monitored. If more then 2 channels needed monitoring the scheme would increase significantly in complexity. The method and apparatus discussed in connection with FIG. 2 addresses the need to monitor and select multiple channels.

FIG. 2 is a block diagram of an exemplary embodiment of a multi-channel color mixing or de-saturation system with a shared DC-DC converter (number of DC-DC converters is less than the number of light sources). With reference to FIG. 2, similar elements from FIG. 1 are labeled with identical reference numbers. In this example embodiment, a supply (LED/Laser) is shown at the top of the drawing as a supply voltage and current source. The light sources, D0-D3 connect to the output of the DC-DC converter. The voltage across the light sources D0-D3 and the current there through is controlled by the drivers associated with each channel labeled Driver0-Driver3.

Connecting to the electrical connection between the drivers and the light source D0-D3 are comparators C0-C3 which monitor each light source and compare this signal to a reference signal from a reference block 112 as shown. In one embodiment the signal comprises a headroom signal and the headroom signal is compared to a desired headroom value (headroom reference). The term headroom is defined herein as the voltage that allows the driver to deliver the current required to turn on the diodes (light sources) and produce the desired light output.

The comparators C0-C3 compare the light source headroom signal to the reference signal. Based on this comparison the comparators C0-C3 output a logic zero (0) or logic one (1). The information (digital output) from the comparators is processed by the LED selector state machine 120 according to few simple rules. The LED selector state machine 120 may comprise a processor, control logic, ASIC, or any other type circuit capable of performing as set forth herein. In this embodiment a 0 output from the comparator indicates that the associated driver is operating at a lower headroom then what is required for its proper operation (so it is a reference signal which depends on may depend on many parameter: architecture of the driver, current to be delivered, etc. or could be a fixed reference voltage. As a result, the rule of operation for this embodiment is that when multiple 0 or multiple 1 signals are presented to the LED selector 120, the output of the LED selector does not change and hence the configuration of the switch 130 does not change. The configuration of the switch 130 changes only when there is a single comparator output at 0, which is to say that only one channel has its driver operating at a headroom value less than what is required for proper operation (meaning the anode voltage is too low and must be raised). If this occurs then the switch 130 will be connected to that one channel which has a comparator outputting the only 0 output. This indicates that this channel's headroom value is too low.

The switch output connects to an analog feedback loop 124. In other embodiments, the output of the switch 130 may connect to any other device that is configured function as the described analog feedback loop. The feedback loop 124 could also be embodied in a digital format. The analog feedback loop 124 operates to sets the supply signal from the DC-DC convertor at the right level to properly bias the active light source. Stated another way, the analog feedback loop acts on the feedback signal of the DC-DC converter to increase/decrease the DC-DC converter voltage and with that the anode voltage (supply) of the VLED and therefore the headroom of the driver. The output of the feedback loop 124 connects to the DC-DC converter 100. The DC-DC converter 100 generates the supply voltage to the light sources D0-D3.

By connecting the switch 130 to the optical channel as described above, the output of the switch and the switch itself establishes a loop which includes the optical channel (one of D0-D3), the feedback loop 124 and the DC-DC convertor 100. This operational rule allows the selection of the channel in the loop with the highest VLED drop (lower headroom) and will force the DC-DC converter to increase the LED/Laser supply to the level that will properly bias the light source D0-D3. In this embodiment the DC-DC converter increases its output because inside the DC-DC converter is an error amplifier configured to compare the external V_{FB} pin with an internal accurate reference voltage. If the V_{FB} is lower then the reference voltage the internal circuitry of the DC-DC converter forces its output to increase.

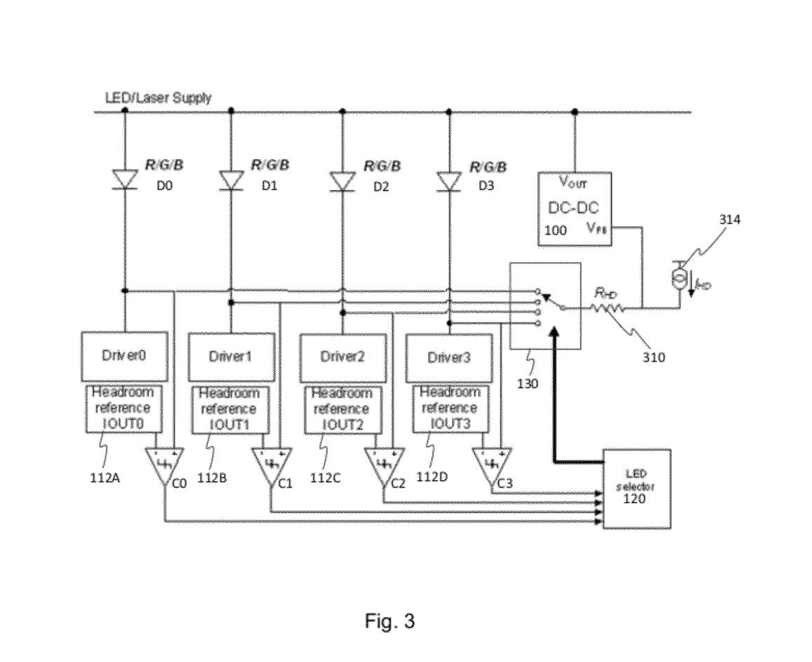

An example implementation of an analog feedback loop is shown in FIG. 3. FIG. 3 is a block diagram of an exemplary embodiment of an analog feedback loop in a color mixing or de-saturation system with a single DC-DC converter. In this embodiment, identical or similar elements are labeled with identical reference numbers. Only the aspects of FIG. 3 which differ from FIG. 2 are discussed below. In this embodiment the comparator C0-C3 and light source output selection scheme operates as described above. In this embodiment the switch 104 will select the light source D0-D3 with the highest drop. A resistor R_{HD} 310 and a current source I_{HD} are provided in this embodiment to establish a voltage V_{HD}. In this configuration, the headroom of the driver associated with the light source D0-D3 (such as an LED) with the highest drop is determined by the V_{FB} (voltage feedback) of the DC-DC converter 124 minus the voltage given by the I_{HD} times R_{HD}. Hence, the current I_{HD} through the resistor 310, shown as R_{HD} is subtracted from the voltage Vₚ which in turn sets the headroom for the driver. Therefore, as the switch 130 selects a different channel 0-3, the voltage output by the switch will change. As a result, the voltage across the resistor R_{HD} 310 will change. When the loop is in stable state the V_{FB} can be considered a virtual ground. The resistor and the currents are needed to reduce the headroom. The V_{FB} could be connected directly to the output but usually the V_{FB} is a fairly high voltage (typically a bandgap voltage ˜1.2V) and that would impact the efficiency of the system.

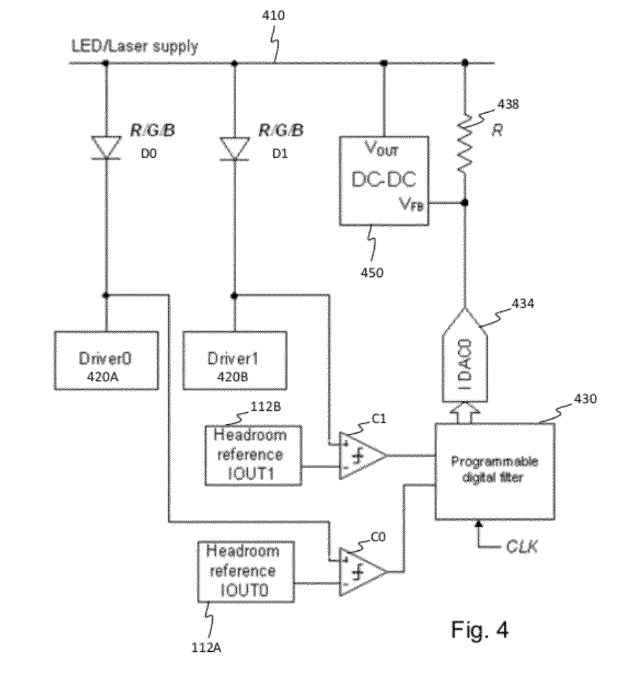

FIG. 4 is a block diagram of an exemplary embodiment of a color mixing or de-saturation system having a single DC-DC converter and a digital to analog converter sourcing current based on a code. This is but one possible embodiment and as such it is contemplated that one of ordinary skill in the art may arrive at alternative but related embodiments. With reference to FIG. 4, a supply 410 is provided to provide a voltage to light source D0-D1. The light source may comprise any light source including but not limited to diodes or lasers. Although shown with only two light sources D0-D1 for purposes of discussion, it is contemplated that this layout may be expanded to any number of channels. The opposing terminal of the light sources D0-D1 connects to drivers 420 and as an input to a comparator C0-C1. The drivers 420 provide the drive current to the light sources to achieve light output to generate the image, whether still or motion based. The drive current may also be referred to as headroom.

The comparators C0-C1 compare the headroom to a reference value, which is received from the headroom reference blocks 112. The reference block 112 may comprise any device capable of generating a reference voltage or signal. The outputs of the comparators C0-C1 connect to a digital filter 430, which in this example embodiment is programmable. The digital filter 430 also receives a clock signal as shown. The digital filter 430 processes the inputs from the comparators to generate a digital code. The output of the digital filter 430 comprises a signal, which is provided to a current sourcing digital to analog converter (DAC) 434. As is understood, the current DAC converts the digital signal to analog format, which is provided to a resistor R 438 and a DC-DC converter 100. The opposing terminals of the resistor R 438 and the DC-DC converter 100 connect to the supply node 450.

In operation, the light sources D0-D1, drivers 420, comparators C0-C1 and the headroom reference signal generators 112 operate as described above. The digital filter receives as inputs the logic one and logic zero outputs from the comparators C0-C1. These values represent whether the DC-DC converter output is above or below the headroom reference signal. The digital filter output is a signal representative of the comparator output. In this configuration, the current DAC 434 pushes an amount of current into the resistor R 438 that is related to or controlled by the signals from the comparators C0-C1. When the DC-DC converter loop is closed (i.e. the part operates in stable conditions) the V_{FB} voltage is constant therefore the output of the DC-DC converter is given by the equation V_{FB}+I_{DAC}·R.

The code for the DAC 434 is generated by a digital filter 430 which, in its simplest embodiment, is a counter that counts up or down depending on the input from the headroom monitoring comparators C0-C1 according to, for this example embodiment, the following rule: if any of the comparator output is low (0) increase the output code otherwise decrease the output code from the digital filter 430. An increase in the output code from the digital filter 430 corresponds to an increase in IDAC current from the DAC 434 and therefore and increase in DC-DC converter output (LED/laser supply).

When both drivers 420 are turned on at the same time, they provide the desired current to their respective light sources D0-D1 (LED/lasers) as long as the headroom across them is sufficient for the desired current. Each light source D0-D1 (LED/lasers) D0-D1 will have its own voltage drop depending on its characteristics and the current that flows through it. The comparator C0-C1 compares the headroom reference with the actual reference and, if one of the actual headroom values is below the desired value, the output of the respective comparator C0-C1 will be low therefore the current from the IDAC 434 will be increased and with it the output of the DC-DC converter 450 which in turn will raise the headroom.

In this manner, the system will reach stability around the point where the driver 420 associated with the light sources D0-D1 (LED/lasers) D0-D1 with the highest drop will operate at its optimal headroom as specified by the headroom reference.

Compared to the previous method and apparatus shown in FIGS. 2 and 3, in this scheme the light sources do not come into the DC-DC converter loop (the DC-DC converter loop is closed through the resistor R as opposed to the light sources D0-D1 (LED/lasers) and R_{HD} in the other method). This makes the system easier to control and make stable. However, unless a very fast digital engine is used this method and apparatus usually yields higher output voltage settling times and therefore slower current settling times, when the current in the light sources is changed or the DC-DC converter is switched to other sources.

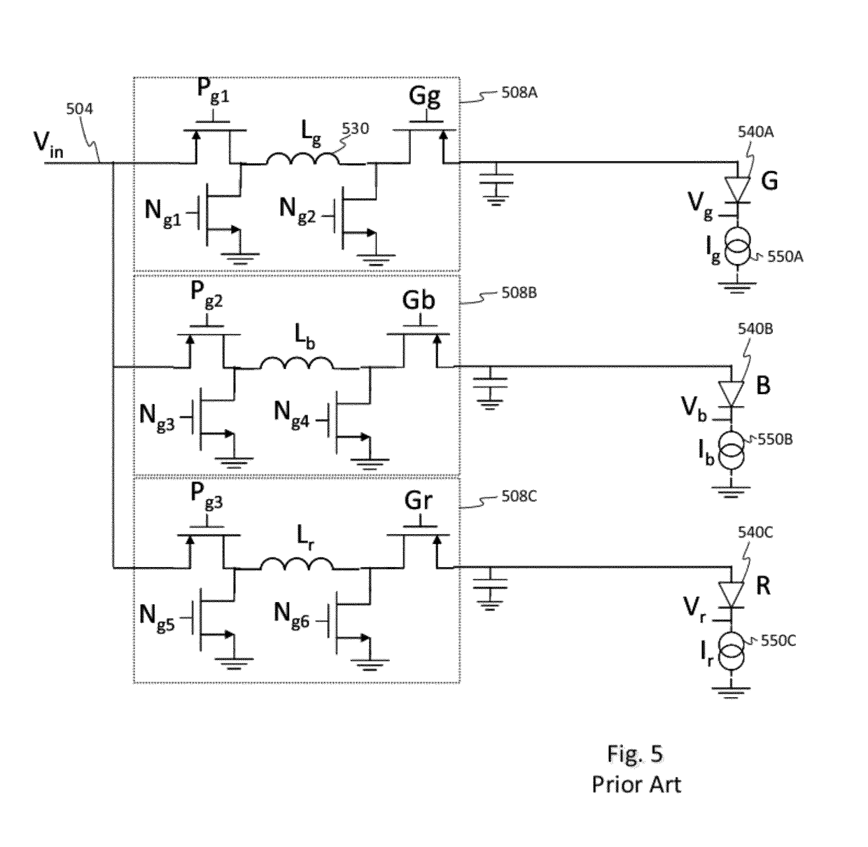

It is further contemplated that instead of the prior art method of associating an inductor with each channel of the projector, the projector may be built around a single input, multiple output inductor (SIMO). For purposes of discussion, FIG. 5 illustrates an example embodiment of a projector system having three light sources with an inductor associated with each channel. As discussed above, in a LCD/LCoS/DLP portable projector system the light is typically generated and provided by three light sources: a red, green and blue source, and the image is created by generating and filtering sequentially these colors with an LCD/LCoS/DLP engine. In other embodiments any type projector system may be used. The LCD/LCoS/DLP is a matrix of pixels where each one can be made transparent or opaque to light. It is between the light source and the projected image. The projected image is created by shining through or blocking (selectively for each pixel) the light from the light sources. Each of the light sources is on for roughly one third of the duration of a frame. The slow reaction time of the human eye is such that each frame is perceived in full color because the colors are rapidly turned on in sequence.

In this prior art system shown in FIG. 5, the DC-DC converter and light source components are configured such that an inductor is associated with each DC-DC converter. In the system of FIG. 5, a voltage Vᵢₙ is provided on an input 504 which provides the voltage Vᵢₙ to dedicated DC-DC converters 508A, 508B, 508C associated with each channel. The DC-DC converters 508 may perform current or voltage step down or step up to suit system design. In this application the DC-DC converters 508 may comprise switching DC-DC converters and operation in connection with the current source drivers 550 (discussed below) to adjust the input voltage Vᵢₙ to the needs of the light sources described below. The DC-DC converters 508 also minimizes voltage drop. In this example embodiment the DC-DC converter 508A is part of the channel that generates the green light signal. The DC-DC converter 508B is part of the channel that generates the blue light signal. The DC-DC converter 508C is part of the channel that generates the red light signal.

The DC-DC converters 508 each include an inductor 530 and other associated devices such as NFETs and PFETs as shown. The NFETs and PFETS are controlled by control signals presented to the gate of each respective FET. The inductor 530 is a common element within the DC-DC converter and as such is not described in detail herein. In this embodiment, the system has a DC-DC converter 508 and associated inductor 530 for each channel. Thus, for three channels, three inductors are utilized.

The output of each DC-DC converter 508 connects to or is provided to a light source 540A, 540B, 540C. The light sources 540 may comprise any light source as disclosed, described herein, or as would be understood by one of ordinary skill in the art. As described above, the light sources 540 generate light of different colors, at different intensities and at different times, which are combined to generate the image. For example, the light sources 540 may be multiplexed or otherwise controlled to generate the light signal which forms the image. The opposing terminal of the light source 540 connects to a current source driver 550A, 550B, 550C as shown. To achieve desired operation of the drivers 550 and light sources 540, sufficient voltage must be present between the light source and the drivers for the drivers to generate or pull the amount of current to turn on the light sources, i.e. generate light. In one embodiment, a control signal (not shown in FIG. 5) is provided to the driver 550 to control the output and intensity of the light source 540.

A cathode voltage for each light source 540 is identified on FIG. 5 as V_{g} for the green light channel, V_{b} for the blue light channel, and Vᵣ for the red light channel.

Given the fact that the projector is portable it is preferred to use any possible technique to improve power efficiency and to do that the switching DC-DC converters 508 are employed to adjust the voltage V_{g}, V_{b}, and Vᵣ, to the particular needs of laser/LED anode/cathode and to minimize the voltage drop, which in turn increases efficiency. These voltages V_{g}, V_{b}, and Vᵣ may be referred to as sensing voltages or as a headroom voltage. The DC-DC converters 508 in turn should be efficient and therefore it is generally a synchronous switching converter requiring an external low-series-resistance inductor. These low parasitic resistance inductors 530 are typically bigger in volume, for example, larger in size by 4 to 20 times, then other components of the DC-DC converter itself. In this embodiment the DC-DC converters 508 are time multiplexed between the different light sources (this is required by the fact that usually red/green and blue light sources 540 (LED/laser) require a different voltage drop to operate). In highly integrated systems the DC-DC converter 508 is typically integrated with the driver 550 which generates the desired current for the light source 540 (LED/laser) therefore the switching of the converter from one channel to the other is done automatically. In this embodiment, each of the DC-DC converters 508 are always on, such that the FET switches that are part of the DC-DC converter are always switching to provide sufficient current to each capacitor and light source 540 according to each particular light source's voltage and current requirements based on the time multiplexed scheme for each light source. For example, the switching (duty cycle) of the FETs may be adjusted according to the time multiplexed operation of the light source to supply more current when a light source is the primary channel light source and less current when it is the sub-channel light source.

It has been determined that the viewer perceives an increase in image quality when the image is brighter. This is the case even the intensity of each color may be slightly less. Likewise, increasing the image brightness provides a better image when the viewing environment is not dark or dim.

Higher brightness can be obtained by running more current in each light source during the respective sub-frame however this creates other problems in portable projection systems such as larger light source die size and a requirement for higher current capability from the drivers and DC-DC converters. These factors result in a bigger area requirement for circuit realization and higher product cost.

Moreover, for a given system (i.e. combination of light source—DC-DC converter—driver), it is usually possible to increase its brightness by means of color mixing. Color mixing in a personal projection system to increase the brightness of the projected image involves turning on more then one light source at a time. While color mixing may cause the color saturation to suffer, it is generally accepted that the improved brightness is a good trade-off for this minor and often undetected drawback.

Color mixing increases brightness, but it cannot be done with a single DC-DC converter, and hence, multiple DC-DC converters are used as shown in FIG. 5. Therefore, to maintain a high efficiency and to enable color mixing which improves perceived image quality, the projectors employ multiple DC-DC converters (one for each light source). Each inductor must be sized for peak current draw and because each color channel is time multiplexed to be the primary channel drawing peak current for that particular light source, each inductor must likewise be sized sufficiently large to supply the peak current for that light source when it is serving as the primary channel. Given the size of the associated inductors and the complication that this involves from a system and board design standpoint this solution is not optimal. In particular, inductors are larger in size by orders of magnitude than the other associated circuitry shown in FIG. 5 and are most often not integrated. In portable projection systems, an increase in size is unwanted, particularly when circuit board real estate is valuable. In some embodiments the portable projection systems may be of a cellular telephone or smartphone and are thus battery powered. Likewise, each separate discrete inductor is expensive in relation to the integrated elements of the DC-DC converter and the driver. Moreover, each inductor may require EMF shielding, which further adds to the cost and size requirements.

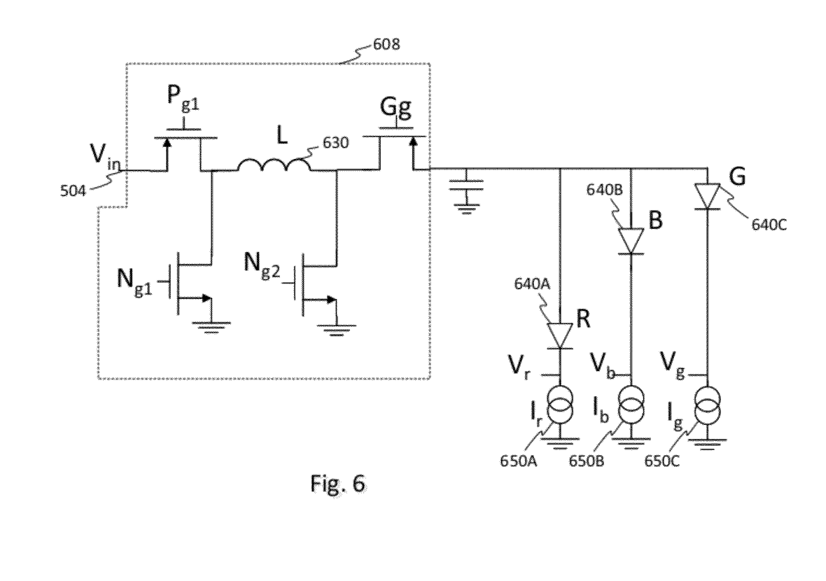

FIG. 6 illustrates an example embodiment of a projector system with a single inductor. In this embodiment, similar elements function as described above in FIG. 5. As shown, a single DC-DC converter 608 is provided which receives an input voltage Vin on input 504. As this is a single DC-DC converter embodiment with a single inductor 630 associated with the singled DC-DC converter 608.

A single output of the DC-DC converter 608 connects to each of the light sources 640A, 640B, 640C. The output of the DC-DC converter 608 may be considered a bias voltage or bias signal. Thus, each light source receives the same DC-DC converter output signal. Connected to the opposite terminal of the light source 640 is a current source driver 650A, 650B, 650C. A control signal (not shown) is provided to the current source drivers 650 to control the voltage levels for Vᵣ, V_{b}, V_{g} and these voltage levels are determined by which light source is the active or full power light source in the time multiplexed image generation arrangement.

The use of a DC-DC converter 608 having a single inductor 630 overcomes the drawbacks described above in connection with a system of FIG. 5 utilizing multiple inductors. However, in the embodiment of FIG. 6, all three light sources 640 share the same single output of the DC-DC converter 608. While this configuration does allow the light sources to operation concurrently in a color mixing scheme, only one of the cathode voltage, (Vᵣ, V_{b}, or V_{g}) can be adjusted at a time. All of the anodes of the light sources must share the same signal from the DC-DC converter 608. This results in less than optimal efficiency because the shared anode voltage from the DC-DC converter is set to the anode voltage for the primary channel. The two other sub-channels are subject to the same output from the DC-DC converter and this output may be less than optimal for these two other sub-channels. This pattern continues during the time multiplexed operation of the system as the sub-channels become the primary channel and the primary channel alternates to a sub-channel status. Because the single output voltage of the DC-DC converter 608 must be set at a level that meets the level light source requiring the highest anode voltage, the output DC-DC converter 608 will be higher than required for the other two light sources. As a result, efficiency is reduced.

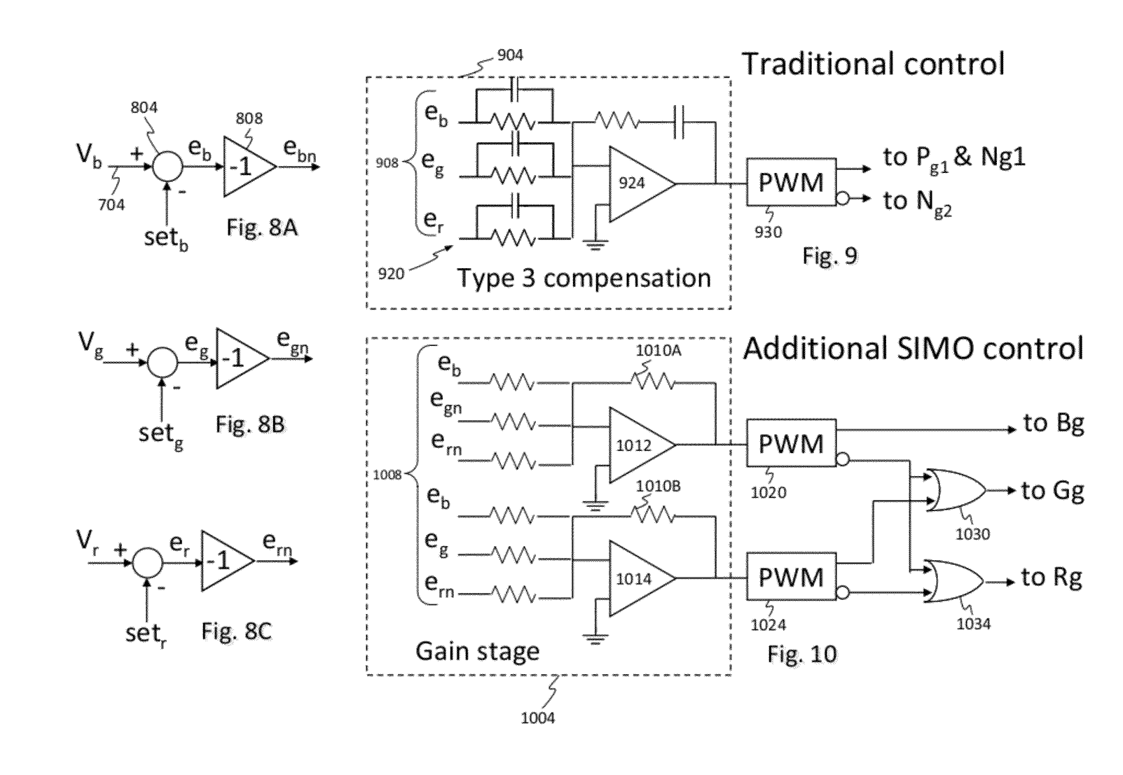

SIMO (single inductors multiple output) converters can be used in color mixing systems, such as in this projector system, or pico-projector systems. These types of converters “share” the external inductor among the multiple output channels. This sharing may or may not occur using a time division multiplexing scheme. The main drawback to SIMO converters, such as SIMO DC-DC converters is that they usually have a higher output ripple especially if all the output channels are under heavy load situations. It should be pointed out that in projector systems using color mixing, only one channel (primary channel) needs to provide high current (the main color during that subframe) while the other channels (sub-channels) need to provide much lower current. Moreover voltage ripple is not extremely important in projector systems since it is a current drive system and thus the output that matters is optical power which is proportional to current. As a result, output voltage ripple is acceptable as long as the current driver can deliver appropriate current output. Moreover, with the integration of the DC-DC converter with the driver, the control scheme of the SIMO converter is optimized because the converter/driver combination can use the information regarding how much current us required by each channel at any given time. Control circuits are discussed below in connection with FIGS. 8-10.

Depending on the light engine, including light sources, used and the supply used for the system (single battery or multiple stacked battery) the type of converter used could be a buck only, a buck-boost or even a boost only (even though other system considerations may prevent the use of a boost only). Depending on the architecture of the converter the overhead for SIMO operation may vary (more switches are required, compared to a single output converter), however from on overall system standpoint, the area advantage gained by having a single inductor is far superior.

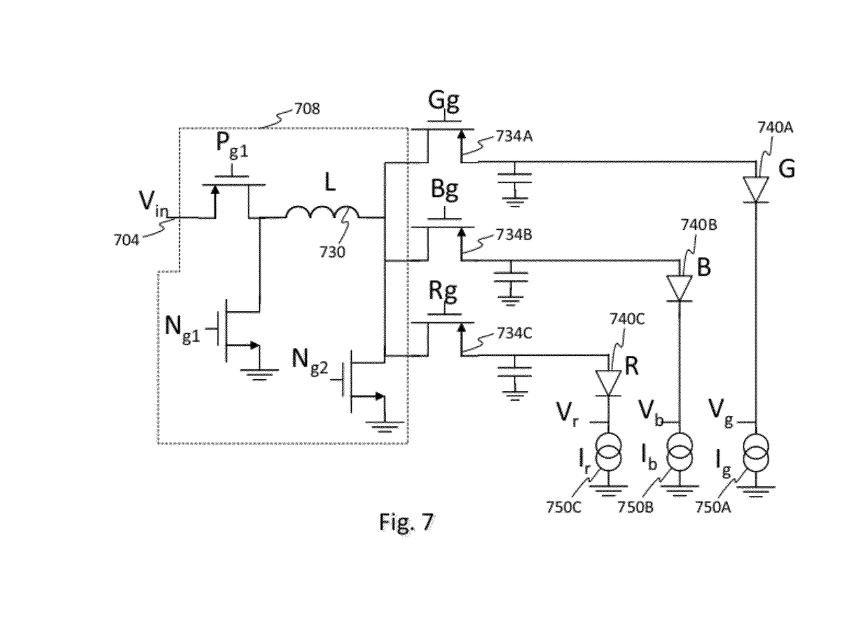

FIG. 7 illustrates an example embodiment of a projector system utilizing a single inductor converter with multiple outputs. This is but one possible embodiment of a projector system utilizing a single inductor converter with a multiple output configuration and it is contemplated that one of ordinary skill in the art, after reading this disclosure, may develop alternative embodiments which do not depart from the scope of this disclosure and the claims that follow.

In this embodiment, an input voltage 704 is presented to the DC-DC converter 708. The DC-DC converter 708 has a single inductor 730 but the output of the DC-DC converter comprises separate output taps. As a result, this DC-DC converter 708 is referred to herein as a single inductor, multiple output (SIMO) device.

Connected in series to each output tap of the DC-DC converter 708 is a control FET 734A, 734B, 734C as shown. The each control FET 734 is controlled by a control signal G_{g}, B_{g}, R_{g}, presented to the gate of each control FET, which corresponds to each color channel for the green, blue and red channels respectively. The opposite terminal of the control FETs 734 connect to the light sources 740A, 740B, 740C as shown. The output of the control FETs 734 may be considered to be the anode voltage of the light sources 740. As described above the opposing terminal (cathode) of the light sources connect to the current source driver 750A, 750B, 750C.

In operation the green, blue, and red color channels share the single inductor that is part of the SIMO based DC-DC converter. The DC-DC converter 708 processes the signal Vᵢₙ to generate sufficient output voltage from the inductor 730. The output voltage from the inductor 730 is presented to each control FET 734. The individual control FETS 734A, 734B, 734C are individually controlled by unique control signals G_{g}, B_{g}, R_{g} provided to the gates of each respective FET to generate the exact anode voltage required by each light sourced connected to each respective control FET. This maximizes efficiency. In other embodiments devices other than FETS for devices 734 may be utilized as one of ordinary skill in the art would appreciate. These devices include but are not limited to FETs (field effect transistor, BJT (bipolar junction transistor), or any other device capable of switching or performing the functions described herein. These FET devices 734 are switched between on or off (conducting, non-conducting) states and are time multiplexed (over longer time blocks) in unison with the time multiplexing of the light source output. The single inductor 730 provides current, which may be generalized as energy, to the devices 734. The duty cycle of the switching in connecting with control of the drivers 750 results in different a different voltages V_{g}, V_{b}, Vᵣ at the cathodes of the light sources 740. The capacitor (shown in FIG. 7) located between the FETs 734 and the light sources 740 stores charge when the FET switch 734 is off. The switching of the FETs 734 occurs at a higher rate than the time multiplexing of the light sources as part of the image creating. By way of example and not limitation, if an image sub-frame has a duration of 1 millisecond, then the FETs 734 may switch every microsecond. This is but one possible timing scenario.

Regardless of which color channel is the primary channel, the FETS 734 switch to provide the needed current. The driver 750 pulls the current and regulates the current, which is sourced from the DC-DC converter 708, 734. The duty cycle of the FETS (switches) 734 changes to accommodate amount of current which is required for a color channel depending on whether that color channel is the primary channel or a sub-channel at any particular time during time multiplexed operation of the light sources 740.

For purposes of discussion, when the primary channel in the time multiplexed system is the green channel then the red channel and the blue channel are the sub-channels. In a time multiplexed system, which channel is the primary channel and which channels are the sub-channels changes over time.

In this embodiment it is preferred to maintain the voltage Vᵣ, V_{b}, V_{g} at the driver generally constant. The output of FET 734 switches (based on rate of switching) depends on the current through light source, which will change depending on whether that light source is the primary channel (full brightness) light source or a subchannel light source, which may be on at a level of 50% or less, or less than full power, or only 10% brightness. The current that is drawn by a channel changes dependent on whether a channel is an active channel or a sub-channel Control inputs (not shown) to the current sources 750 determine the light intensity. The control inputs may be from any device such a controller, processor, image signal processor, or any other device. In one embodiment a digital to analog converter receives a digital code to thereby control the current through the light source for that channel. A digital controller (not shown) or other control devices such as a processor, ADC, ASIC, DSP, switch, multiplexer, or control logic is provided to control which light source (or channel) is the primary light source according to the time multiplexing scheme. It is the drivers 750 (controlled by the digital code/control signal) which determine which channel is the primary channel and which channel(s) are the subchannels.

Due to the unique control signals G_{g}, G_{b}, Rᵣ, provided to the control FETS 734 and the control signals to the drivers, each channel is individually controlled and the precise and desired cathode voltage (headroom signal) may be presented to the light source 740 associated with each channel. Thus, this embodiment has the benefit of individual channel control which in turn results in greater or maximum efficiency because each cathode voltage need only be established at the specific voltage level required for operation of the light source associated with that particular channel.

Moreover, this embodiment only utilizes a single inductor. This overcomes the drawbacks described above with systems that employ multiple inductors, yet enables individual control of the cathode voltage for each channel. In this embodiment it is preferred to have the voltage across the driver, or presented to the light source as V_{b}, V_{g}, Vᵣ at a value that is at least a minimum as specified by the design and which is typically defined by the light source. By adjusting the voltage to the minimum required, power is saved. In one embodiment the cathode voltages Vᵣ, V_{b} and V_{g} are kept constant.

It is also contemplated that this configuration and principle may be extended to any number of different color channels or light sources. In the case of different number of color channels, the SIMO DC-DC converter may have any number of two or more output taps. For example, some color projectors may utilize more colors than green, blue, red. In addition, the system maybe configured with multiple light sources of the same color. This would increase brightness, or provide other benefits while still provide the benefit of individual channel or light source power control in a system having a DC-DC converter with a single inductor.

In this embodiment and in general, the inductor should be sized to supply sufficient power to its multiple outputs. Sufficient power which is determined by the load of the light sources. Hence, in one embodiment the inductor is sized based on the light source energy draw. In contrast to the prior art which used a dedicated inductor for each color channel, the SIMO DC-DC converter utilizes a single inductor to power all the outputs. As a result, the inductor in the SIMO DC-DC converter may be slightly larger in size, and thus have greater power sourcing capability since it is driving all the color output channels. However, the inventors determined that only one channel is fully driven at a time and the other two channels are not fully powered since they are not at full brightness, and hence require less power. Thus, the overall power required from the inductor is not the full power of each channel, but full power from one channel and then a portion of full power from the other two channels.

The SIMO DC-DC converter may not have as high of efficiency as a DC-DC converter with a dedicated inductor. This loss in efficiency may be 1 to 2 percent. This is yet another reason to an inventor may not use the SIMO DC-DC convertor.

In general, SIMO DC-DC converters suffer from the drawback that the voltage which is regulated on any one output depends on the load at the other outputs. This can cause the accuracy or precision of the signal on of any output to suffer, subject to the load on the other outputs. Likewise, noise on one channel may affect the accuracy of the other output channels. This characteristic of SIMO DC-DC converters has lead designers away from use of the SIMO DC-DC converters in projection systems. However, in this application, each of the sub-channels is only drawing a small percentage of power in relation to the primary output and the power draw may be stable. In addition, the inventors discovered that in the image projector application, the current flow stability is of importance. A small variation in the output will be corrected by the loop and this does not affect system performance as long as the light source is provided the required current intensity.

FIGS. 8A-8C illustrate example embodiments of circuitry configured to generate control signals utilized in generating DC-DC converter control signals such as for the SIMO DC-DC converter of FIG. 7. FIGS. 8A-8C are generally similar in circuit structure and as such FIGS. 8A-8C are discussed as a group. As shown in FIG. 8A, the voltage V_{b} 704 as referenced in FIG. 7 is presented to a summing junction 804. The summing junction also receives a reference signal, set_{b} which is provided to the summing junction as a negative input or which may subtracted, in the event the junction 804 is a subtractor, from the signal V_{b}. The resulting output is an error signals e_{b}, which is provided to an inverter 808, or any devices which inverters or changes a positive input to a negative value. The output of the inverter 808 is a signal e_{bn}.

The circuit operation and construction of the circuits of FIG. 8B is generally similar to that of FIG. 8A. The input is V_{g} and the reference signal is set_{g}. The resulting error signal and its inverted value is e_{g} and e_{gn} respectively. The circuit operation and construction of the circuits of FIG. 8C is generally similar to that of FIG. 8A. The input is Vᵣ and the reference signal is setᵣ. The resulting error signal and its inverted value is eᵣ and eₘ respectively.

In one embodiment these error signals represent the difference between a reference voltage value (set) and the actual cathode voltage shown in FIG. 7, which is shown as V_{b}, V_{g}, and Vᵣ. The reference voltage value represents the desired cathode voltage. In this embodiment it is desired to establish the actual cathode voltage Vᵣ, V_{b}, V_{g} to the same general value as a predetermined value determined by the setᵣ, set_{g}, setᵣ values. In other embodiments, other values may be established or offsets may be created.

Turning now to FIG. 9, an example controller is shown for generating the outputs P_{g1}, N_{g1} and N_{g2} which are presented to the DC-DC converter as shown in FIG. 7. In this embodiment, type 3 compensation is utilized, but in other embodiments other compensation schemes may be used. In general, the output of the power stage of the DC-DC converters is compared to a target which in turn regulates the output to a desired value or magnitude. Feedback occurs into a compensation network that drives the power generation aspects of the DC-DC converter. As a result, the three error signal input type 3 compensation is used. The simplest type of compensation is a type 1 and type 2 but this application may benefit from a more complicated compensation system to gain greater stability and speed. This system generates one or more of the control signals which are provided to the PFTs within the DC-DC converter 508, 608 shown in FIGS. 5 and 6. A compensation network 904 contains RC networks 920 and an amplifier 924. The signals e_{b}, e_{g}, eᵣ from the circuits shown in FIG. 8 are presented as inputs to the RC networks 920. The outputs of the RC networks 920 fed into a series connected RC path and the amplifier 924. The output of the amplifier 924 and the series connected RC path connect to a pulse width modulator (PWM) 930. The PWM 930 operates as is understood in the art to provide the outputs as shown for P_{g1} and N_{g1} and an inverted output Ng₂. These outputs are presented to the gate inputs of the PFTs shown in the DC-DC converter 508A of FIG. 5. It is contemplated that a controller 904 may be provided for each DC-DC convertor 508A, 508B, 508C and the output of each controller 904 would be tailored for that particular DC-DC converter.

FIG. 10 illustrates an example embodiment of a controller for a SIMO DC-DC Converter. This is but one example embodiment and other embodiments may be created without departing from the scope of this innovation. As discussed above in connection with FIG. 9, the controller of FIG. 10 provides the control signals to the SIMO DC-DC converter 708 shown in FIG. 7.

A gain stage 1004 includes a resistor network 1008 which accepts the inputs e_{b}, e_{g}, eᵣ, e_{gn}, eₘ, and eₘ which are generated by the circuits shown in FIGS. 8A-8C. The output of the resistor network connects to both resistor 1010A, 1010B and amplifiers 1012, 1014 as shown. The output of the resistors 1010A, 1010B connect to a common node with the amplifier output. The output of each amplifier feeds into a pulse width modulator (PWM) 1020, 1024 which operates as is understood in the art by performing pulse width modulation of the signal.

The output of the PWM 1020 comprises signal B_{g} and an inverted output which is presented to OR gate logic devices 1030 and 1034. The other PWM 1024 has a first output that is provided as a second input to the OR gate 1030 while the other output of the PWM 1024 is inverted and provided as the second input to the OR gate 1034. The output of the first OR gate 1030 comprises signal G_{g}. The output of the second OR gate 1034 comprises signal R_{g}. Signal B_{g}, G_{g}, and R_{g} are presented as inputs to the PFTs 734A, 734B, 734C turn on and off the PETS, which act as switches. The regulation is performed by changing the duty cycle of the switch, which in turn charges the capacitor thereby controlling the voltage presented to each light source.

The input to the PWM units 1020, 1024 is created by combining the error signals, based on the difference between the set values and the Vb, Vg, Vr. In this example embodiment, the blue channel is positive so high blue channel error indicates it is above or larger than the set (target) value for the blue channel. Amplifier 1012 processes the signal of a higher blue channel error to provide a lower output to the PWM 1020. This results in a lower or slower input to the gate of the FET for the blue channel, which in turn reduces the duty cycle. But with type 3 compensation, the blue channel duty rate is also based on the error on the other channels.

In this embodiment the SIMO DC-DC converter of FIG. 7 has or utilizes the circuitry or functionality shown in FIGS. 9 and 10. While the complexity of the circuit of FIG. 10 is slightly greater than the complexity of a circuit having type 1 or 2 compensation, the slight increase in complexity is well worth the benefits gained by the SIMO DC-DC converter.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A color mixing projector system with a single input, multiple output inductor DC-DC converter comprising:
a DC-DC converter having two or more outputs and a single inductor;
two or more light sources such that at least one of the two or more light sources are configured to receive a voltage supplied by at least one output of the two or more outputs from the DC-DC converter; and
one or more drivers configured to drive the one or more light sources subject to a time multiplexed projection scheme.

2. The system of claim 1, further comprising a control device in between at least one light source and at least one output of the two more outputs of the DC-DC converter.

3. The system of claim 2, wherein the control device comprises a field effect transistor.

4. The system of claim 1, wherein the magnitude of the voltage supplied by each of the outputs of the DC-DC converter is determined by a control signal.

5. A color mixing projector system with a single input, multiple output inductor DC-DC converter comprising:
a DC-DC converter having:
one input configured to receive an input voltage;
a single inductor;
two or more outputs;
a switch between the single inductor and the two or more outputs;
two or more light sources such that at least one of the two or more light sources is configured to receive an output voltage supplied by the at least one output of the two or more outputs from the DC-DC converter, the output voltage having a magnitude related to a turn on voltage from the at least one light source; and
a current source associated with each light source, the current sources configured to drive the one or more light sources subject to a time multiplexed projection scheme.

6. A method for generating a projected image, the method comprising:
to receiving an input voltage on a single input to a DC-DC converter;
during a first time period associated with a first light source,
processing the input voltage with a single inductor within the DC-DC
converter to generate a first DC-DC converter output;
presenting the first DC-DC converter outputs to two or more light sources, the first DC-DC converter output having a magnitude tailored to the first light source;
responsive to first DC-DC converter output and a control input presented to a current source for the first light source, generating a light output signal from two or more light sources during the first time period;
during a second time period associated with a second light source,
processing the input voltage with a single inductor within the DC-DC converter to generate a second DC-DC converter output;
presenting the second DC-DC converter output to two or more light sources, the second DC-DC converter output having a magnitude tailored to the first light source and different than the first DC-DC converter output; and
responsive to second DC-DC converter output and a control input presented to a current source for the second light source, generating a light output signal from two or more light sources during the second time period.

7. The method of claim 6, wherein the first light source is of a first color and the second light source is of a second color and the first color is different than the second color.

8. The method of claim 7, wherein during the first time period the light output from the first light source is of a first magnitude and during the second time to period the light output from the first light source is of a second magnitude, the first magnitude being different from the second magnitude.
